(19) United States
(12) Patent Application Publication
(10) Pub. No.: US 2016/0180322 A1
(43) Pub. Date: Jun. 23, 2016

(54) MOBILE TERMINAL AND CONTROL METHOD THEREOF

(71) Applicant: LG ELECTRONICS INC., Seoul (KR)

(72) Inventors: Hosung SONG, Seoul (KR); Keansub LEE, Seoul (KR); Youngjoo SON, Seoul (KR); Junho LEE, Seoul (KR)

(73) Assignee: LG ELECTRONICS INC., Seoul (KR)

(21) Appl. No.: 14/909,958

(22) PCT Filed: Aug. 11, 2014
(86) PCT No.: PCT/KR2014/007461

§ 371 Date: Feb. 3, 2016

(30) Foreign Application Priority Data
Oct. 7, 2013 (KR) 10-2013-0119340

(51) Int. Cl. G06Q 20/32; H04L 29/06; G06Q 20/40; G06F 17/30

(52) U.S. Cl. CPC G06Q 20/3226; G06F 17/3087; H04L 63/0861; H04L 63/083; G06Q 20/405

(57) ABSTRACT

The present invention relates to a mobile terminal capable of transmitting and receiving position information, and a control method thereof. The mobile terminal comprises: a user input unit configured to receive, from a user, at least one of information to be considered to search for a financial transaction terminal adjacent to the user, and authentication information; a controller configured to search for one or more financial transaction terminals adjacent to the user, based on the information to be considered to search for a financial transaction terminal, and configured to detect usage situation information on said one or more financial transaction terminals; and a display unit configured to output the usage situation information, wherein if the user moves to arrive at one of said one or more financial transaction terminals, the controller transmits the input authentication information to said one financial transaction terminal.

### TECHNICAL FIELD

The present disclosure relates to a mobile terminal, and particularly, to a mobile terminal capable of transmitting and receiving position information, and a control method thereof.

### BACKGROUND ART

A mobile terminal is a device that can be carried around and has one or more functions such as to perform voice and video call communications, inputting and outputting information, storing data, and the like.

As functions of the terminal become more diversified, the terminal can support more complicated functions such as writing memos, receiving and transmitting e-mails and managing schedules. By comprehensively and collectively implementing such functions, the mobile terminal may be embodied in the form of a multimedia player or a device.

Various attempts have been made to implement complicated functions in such a multimedia device by means of hardware or software.

Owing to such improvements, the mobile terminal may transmit and receive positional information through a GPS, etc. For instance, the mobile terminal may receive information on a user's current position and a position of an adjacent branch where an ATM is provided.

However, in this case, a financial institution to be transacted by a user, a transaction type, the amount of money, and a user's schedules cannot be considered. Further, in a case where a user requests another person to perform a transaction using a user's account, or in a case where the user uses an ATM, personal information may leak to outside when a user's account number or password is input.

### DISCLOSURE

### Technical Problem

Therefore, an object of the present invention is to provide a mobile terminal capable of enhancing a user's convenience by searching for a financial transaction terminal with consideration of a user's position, a financial transaction type and financial transaction situations, and a control method thereof.

### Technical Solution

To achieve these and other advantages and in accordance with the purpose of the present invention, as embodied and broadly described herein, there is provided a mobile terminal for transmitting and receiving position information, the mobile terminal comprising: a user input unit configured to receive, from a user, at least one of information to be considered to search for a financial transaction terminal adjacent to the user, and authentication information; a controller configured to search for one or more financial transaction terminals adjacent to the user, based on the information to be considered to search for a financial transaction terminal, and configured to detect usage situation information on said one or more financial transaction terminals; and a display unit configured to output the usage situation information. Once the user moves to arrive at one of said one or more financial transaction terminals, the controller may transmit the input authentication information to said one financial transaction terminal.

In an embodiment, the user input unit may receive at least one of a financial institution to be transacted by the user, a transaction type, the amount of money, and a user's schedules, as information to be considered to search for the financial transaction terminal.

In an embodiment, the controller may search for said one or more financial transaction terminals, with consideration of a user's moving path calculated based on the input user's schedules.

In an embodiment, the user input unit may receive at least one of the user's fingerprint, password and face photo, as the authentication information.

In an embodiment, the controller may generate a virtual account corresponding to a desired account for a financial transaction whenever an event of the financial transaction occurs.

In an embodiment, the display unit may output authentication information of another person who is to access a user's account.

In an embodiment, once the user moves to arrive at a place around or adjacent to a plurality of financial transaction terminals, the user input unit may receive the user's touch input to search for one of the financial transaction terminals. The controller may select one of the plurality of financial transaction terminals based on the user's position, and may calculate a positional relation between the user and the selected financial transaction terminal upon the user's touch input.

In an embodiment, the mobile terminal may be implemented as smart glasses. The user input unit may be implemented as a virtual keypad. Once a user arrives at one of one or more searched financial transaction terminals, the virtual keypad can receive inputtable signals from said one financial transaction terminal, and can recognize the received signals through the smart glasses.

To achieve these and other advantages and in accordance with the purpose of this specification, as embodied and broadly described herein, there is provided a method for controlling a mobile terminal, the method comprising: (a) receiving, from a user, information to be considered to search for a financial transaction terminal around or adjacent to the user or the mobile terminal; (b) searching for one or more financial transaction terminals around or adjacent to the user or the mobile terminal, based on the information to be considered to search for a financial transaction terminal; (c) detecting and outputting usage situation information on said one financial transaction terminal; and (d) when the user or the mobile terminal moves to arrive at one of said one or more financial transaction terminals, transmitting authentication information input by the user to said one financial transaction terminal.

In an embodiment, the step (a) may include receiving at least one of a financial institution to be transacted by the user, a transaction type, the amount of money, and a user's schedules, as information to be considered to search for the financial transaction terminal.

In an embodiment, the step (b) may include searching for said one or more financial transaction terminals, by considering a user's moving path calculated based on the received user's schedules.

In an embodiment, the step (d) may include receiving at least one of a user's fingerprint, password and face photo, as the authentication information.

In an embodiment, the step (d) may include generating a virtual account corresponding to a desired account for a financial transaction whenever an event of the financial transaction occurs.

In an embodiment, the step (d) may include outputting authentication information of another person who is to access a user's account.

In an embodiment, the step (c) may include selecting one of a plurality of financial transaction terminals based on a user's position if the user moves to arrive at a place around or adjacent to the plurality of financial transaction terminals, and calculating a positional relation between the user and the selected financial transaction terminal upon the user's touch input to arrive at the selected financial transaction terminal.

The step (d) may include transmitting authentication information received from the user, to the selected financial transaction terminal, if the user arrives at the selected financial transaction terminal.

In an embodiment, the step (a) may include receiving inputtable signals from one of said one or more financial transaction terminals, and outputting a virtual keypad recognizable through smart glasses, if the user arrives at said one financial transaction terminal.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### Advantageous Effects

In the present invention, a financial transaction terminal can be searched with consideration of a financial institution to be transacted by a user, a transaction type, the amount of money and a user's schedules.

Further, authentication information can be transmitted when a user requests another person to perform a transaction using the user's account. Further, an encoded virtual account number may be generated at the time of each transaction. Further, as the mobile terminal of the present invention is implemented as smart glasses, personal information can be input through a keypad output in a new form each time. Accordingly, personal information can be protected, and a user's convenience can be enhanced.

### DESCRIPTION OF DRAWINGS

FIG. 1 is a block diagram illustrating a mobile terminal according to an embodiment of the present invention;

FIGS. 2A and 2B are conceptual views of a communication system where a mobile terminal according to the present invention can operate;

FIG. 3A is a front perspective view of a mobile terminal according to the present invention;

FIG. 3B is a rear perspective view of the mobile terminal of FIG. 3A;

FIG. 4 is a flowchart to explain a mobile terminal according to an embodiment of the present invention;

FIGS. 5 and 6 are conceptual views illustrating an embodiment of a user interface for searching for a financial transaction terminal with consideration of search conditions and a user's position;

FIG. 7 is a conceptual view illustrating an embodiment of a user interface for transmitting authentication information;

FIG. 8 is a conceptual view illustrating an embodiment to access another person's account;

FIG. 9 is a conceptual view illustrating an embodiment of authentication information transmitted to an account owner;

FIG. 10 is a conceptual view illustrating an embodiment of a user interface for transmitting a virtual account number;

FIG. 11 is a conceptual view illustrating an embodiment where a mobile terminal of the present invention is implemented as smart glasses;

FIG. 12 is a conceptual view illustrating an embodiment to guide a position of an automatic teller machine (ATM);

FIG. 13 is a conceptual view illustrating positions of a user and an ATM; and

FIG. 14 is a conceptual view illustrating an embodiment to transmit data between a mobile terminal of the present invention and an ATM.

### MODE FOR INVENTION

Description will now be given in detail according to the exemplary embodiments, with reference to the accompanying drawings. For the sake of brief description with reference to the drawings, the same or equivalent components will be provided with the same reference numbers, and description thereof will not be repeated. A suffix “module” or “unit” used for constituent elements disclosed in the following description is merely intended for easy description of the specification, and the suffix itself does not give any special meaning or function. In describing the present invention, if a detailed explanation for a related known function or construction is considered to unnecessarily divert the gist of the present disclosure, such explanation has been omitted but would be understood by those skilled in the art. The accompanying drawings are used to help easily understood the technical idea of the present invention and it should be understood that the idea of the present disclosure is not limited by the accompanying drawings.

Mobile terminals described herein may include cellular phones, smart phones, laptop computers, digital broadcasting terminals, personal digital assistants (PDAs), portable multimedia players (PMPs), navigators, slate PCs, tablet PC, ultra books and the like. However, it may be easily understood by those skilled in the art that the configuration according to the exemplary embodiments of this specification can be applied to stationary terminals such as digital TV, desktop computers and the like excluding a case of being applicable only to the mobile terminals.

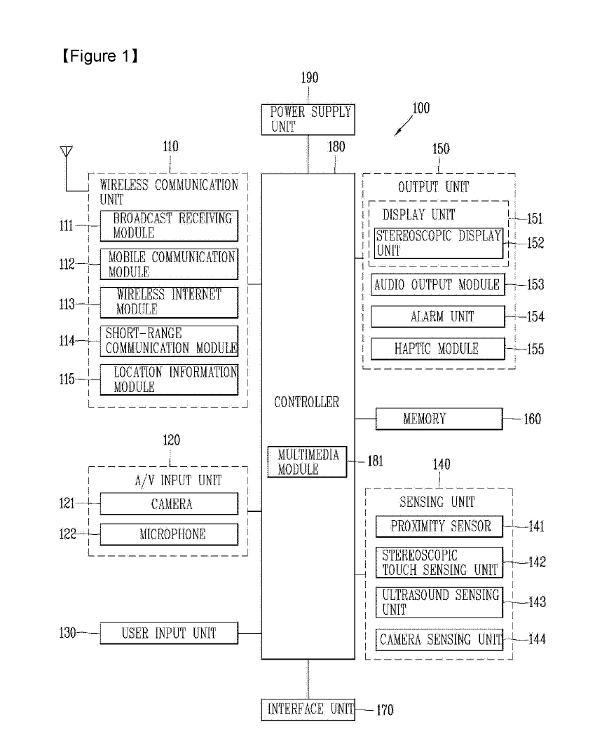

FIG. 1 is a block diagram of a mobile terminal 100 in accordance with one exemplary embodiment.

The mobile terminal 100 may comprise components, such as a wireless communication unit 110, an Audio/Video (NV) user unit 120, a user input unit 130, a sensing unit 140, an output unit 150, a memory 160, an interface unit 170, a controller 180, a power supply 190 and the like. FIG. 1 shows the mobile terminal 100 having various components, but it is understood that implementing all of the illustrated components is not a requirement. Greater or fewer components may alternatively be implemented.

Hereinafter, each component 110 to 190 is described in sequence.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include at least one of a broadcast receiving module 111, a mobile communication module 112, a wireless Internet module 113, a short-range communication module 114, a location information module 115 and the like.

The broadcast receiving module 111 receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module 112 may implement a video call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC) and the like.

The location information module 115 denotes a module for detecting or calculating a position of a mobile terminal. An example of the location information module 115 may include a Global Position System (GPS) module or a Wireless Fidelity (WiFi) module.

Still referring to FIG. 1, the A/V user input unit 120 is configured to provide audio or video signal input to the mobile terminal. The A/V user input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Also, user's position information and the like may be calculated from the image frames acquired by the camera 121. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply 190, the presence or absence of a coupling or other connection between the interface unit 170 and an external device.

The output unit 150 is configured to output an audio signal, a video signal or a tactile signal. The output unit 150 may include a display unit 151, an audio output module 153, an alarm unit 154 and a haptic module 155.

The display unit 151 may output information processed in the mobile terminal 100. For example, when the mobile terminal is operating in a phone call mode, the display unit 151 will provide a User Interface (UI) or a Graphic User Interface (GUI), which includes information associated with the call. As another example, if the mobile terminal is in a video call mode or a capturing mode, the display unit 151 may additionally or alternatively display images captured and/or received, UI, or GUI. The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, an e-ink display or the like.

Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the displays 151 may be arranged on one surface to be spaced apart from or integrated with each other, or may be arranged on different surfaces.

The display unit 151 may also be implemented as a stereoscopic display unit 152 for displaying stereoscopic images.

Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

As illustrated, a left image and a right image required for implementing a 3D stereoscopic image is displayed on the stereoscopic display unit 152 by a stereoscopic processing unit (not shown). The stereoscopic processing unit may receive the 3D image and extract the left image and the right image, or may receive the 2D image and change it into a left image and a right image.

Here, if the display unit 151 and a touch sensitive sensor (referred to as a touch sensor) have a layered structure therebetween (referred to as a ‘touch screen’), the display unit 151 may be used as an input device as well as an output device. The touch sensor may be implemented as a touch film, a touch sheet, a touchpad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller 180. Accordingly, the controller 180 may sense which region of the display unit 151 has been touched.

Still referring to FIG. 1, a proximity sensor 141 may be arranged at an inner region of the mobile terminal 100 covered by the touch screen, or near the touch screen. The proximity sensor 141 may be provided as one example of the sensing unit 140. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor 141 has a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

When a touch sensor is overlaid on the stereoscopic display unit 152 in a layered manner (hereinafter, referred to as ‘stereoscopic touch screen’), or when the stereoscopic display unit 152 and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasonic sensing unit 143, and a camera sensing unit 144.

The proximity sensor 141 detects the distance between a sensing object (e.g., the user's finger or a stylus pen) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 may sense touch pressure. When the pressure is strong, it may recognize the touch as a touch with respect to an object located farther away from the touch screen toward the inside of the terminal.

The ultrasonic sensing unit 143 is configured to recognize position information of the sensing object by using ultrasonic waves.

The ultrasonic sensing unit 143 may include, for example, an optical sensor and a plurality of ultrasonic sensors. The optical sensor is configured to sense light and the ultrasonic sensors may be configured to sense ultrasonic waves. Since light is much faster than ultrasonic waves, a time for which the light reaches the optical sensor is much shorter than a time for which the ultrasonic wave reaches the ultrasonic sensor. Therefore, a position of a wave generation source may be calculated by using a time difference from the time that the ultrasonic wave reaches based on the light as a reference signal.

The camera sensing unit 144 includes at least one of a camera 121, a photo sensor, and a laser sensor.

For example, the camera 121 and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the mobile terminal 100 (e.g., a call signal reception sound, a message reception sound, etc.). The audio output module 153 may include a speaker, a buzzer or the like.

The alarm unit 154 outputs a signal for informing about an occurrence of an event of the mobile terminal 100. Events generated in the mobile terminal may include call signal reception, message reception, key signal inputs, a touch input etc. In addition to video or audio signals, the alarm unit 154 may output signals in a different manner, for example, using vibration to inform about an occurrence of an event. The video or audio signals may be also outputted via the audio output module 153, so the display unit 151 and the audio output module 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be outputted or sequentially outputted.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via the interface unit 170.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, the controller 180 may execute a lock state to restrict a user from inputting control commands for applications when a state of the mobile terminal meets a preset condition. Also, the controller 180 may control a lock screen displayed in the lock state based on a touch input sensed on the display unit 151 in the lock state of the mobile terminal.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

Hereinafter, a communication system which is operable with the mobile terminal 100 according to the present disclosure will be described.

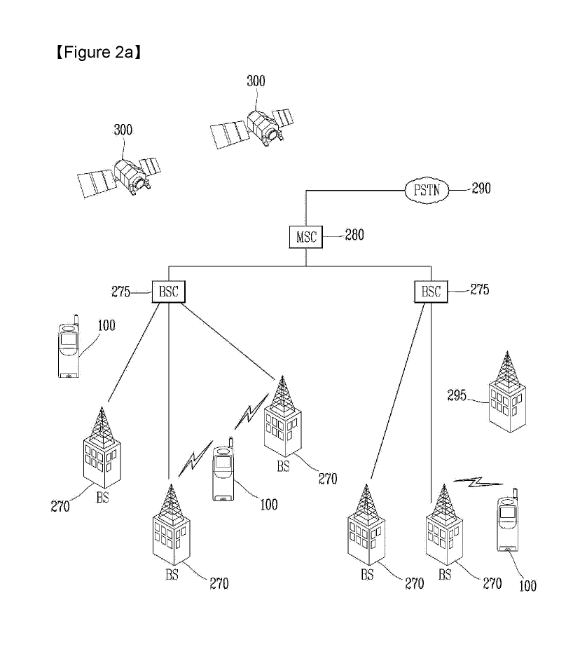

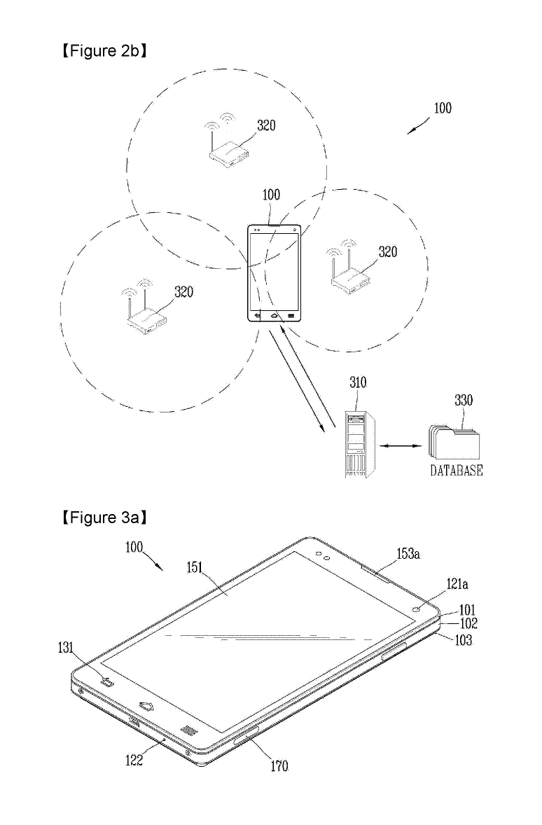

FIGS. 2A and 2B are conceptual views of a communication system operable with a mobile terminal in accordance with the present disclosure.

First, referring to FIG. 2A, such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like.

By way of non-limiting example only, further description will relate to a CDMA communication system, but such teachings apply equally to other system types including the CDMA wireless communication system.

Referring now to FIG. 2A, a CDMA wireless communication system is shown having a plurality of mobile terminals 100, a plurality of base stations (BSs) 270, base station controllers (BSCs) 275, and a mobile switching center (MSC) 280. The MSC 280 is configured to interface with a conventional Public Switch Telephone Network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs 275 can be included in the system as shown in FIG. 2A.

Each base station 270 may include one or more sectors, each sector having an omni-directional antenna or an antenna pointed in a particular direction radially away from the base station 270. Alternatively, each sector may include two or more different antennas. Each base station 270 may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations 270 may also be referred to as Base Station Transceiver Subsystems (BTSs). In some cases, the term “base station” may be used to refer collectively to a BSC 275, and one or more base stations 270. The base stations may also be denoted as “cell sites.” Alternatively, individual sectors of a given base station 270 may be referred to as cell sites.

A broadcasting transmitter (BT) 295, as shown in FIG. 2A, transmits a broadcast signal to the mobile terminals 100 operating within the system. The broadcast receiving module 111 (FIG. 1B) is typically configured inside the mobile terminal 100 to receive broadcast signals transmitted by the BT 295.

FIG. 2A further depicts several Global Positioning System (GPS) satellites 300. Such satellites 300 facilitate locating the position of at least one of plural mobile terminals 100. Two satellites are depicted in FIG. 2, but it is understood that useful position information may be obtained with greater or fewer satellites than two satellites. The GPS module 115 (FIG. 1B) is typically configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

During typical operation of the wireless communication system, the base stations 270 receive sets of reverse-link signals from various mobile terminals 100. The mobile terminals 100 are engaging in calls, messaging, and executing other communications. Each reverse-link signal received by a given base station 270 is processed within that base station 270. The resulting data is forwarded to an associated BSC 275. The BSC 275 provides call resource allocation and mobility management functionality including the orchestration of soft handoffs between base stations 270. The BSCs 275 also route the received data to the MSC 280, which then provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminals 100.

Hereinafter, description will be given of a method for acquiring location information of a mobile terminal using a wireless fidelity (WiFi) positioning system (WPS), with reference to FIG. 2B.

The WiFi positioning system (WPS) 300 refers to a location determination technology based on a wireless local area network (WLAN) using WiFi as a technology for tracking the location of the mobile terminal 100 using a WiFi module provided in the mobile terminal 100 and a wireless access point 320 for transmitting and receiving to and from the WiFi module.

The WiFi positioning system 300 may include a WiFi location determination server 310, a mobile terminal 100, a wireless access point (AP) 320 connected to the mobile terminal 100, and a database 330 stored with any wireless AP information.

The WiFi location determination server 310 extracts the information of the wireless AP 320 connected to the mobile terminal 100 based on a location information request message (or signal) of the mobile terminal 100. The information of the wireless AP 320 may be transmitted to the WiFi location determination server 310 through the mobile terminal 100 or transmitted to the WiFi location determination server 310 from the wireless AP 320.

The information of the wireless AP extracted based on the location information request message of the mobile terminal 100 may be at least one of MAC address, SSID, RSSI, channel information, privacy, network type, signal strength and noise strength.

The WiFi location determination server 310 receives the information of the wireless AP 320 connected to the mobile terminal 100 as described above, and compares the received wireless AP 320 information with information contained in the pre-established database 330 to extract (or analyze) the location information of the mobile terminal 100.

On the other hand, referring to FIG. 2B, as an example, the wireless AP connected to the mobile terminal 100 is illustrated as a first, a second, and a third wireless AP 320. However, the number of wireless APs connected to the mobile terminal 100 may be changed in various ways according to a wireless communication environment in which the mobile terminal 100 is located. When the mobile terminal 100 is connected to at least one of wireless APs, the WiFi positioning system 300 can track the location of the mobile terminal 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the mobile terminal 100 from the database 330 to extract the location information matched to the searched wireless AP, thereby extracting the location information of the mobile terminal 100.

Furthermore, the extracted location information of the mobile terminal 100 may be transmitted to the mobile terminal 100 through the WiFi location determination server 310, thereby acquiring the location information of the mobile terminal 100.

Hereinafter, a mobile terminal according to an embodiment of the present disclosure as illustrated in FIG. 1 or a mobile terminal disposed with the constituent elements of the mobile terminal or the structure of a mobile terminal will be described.

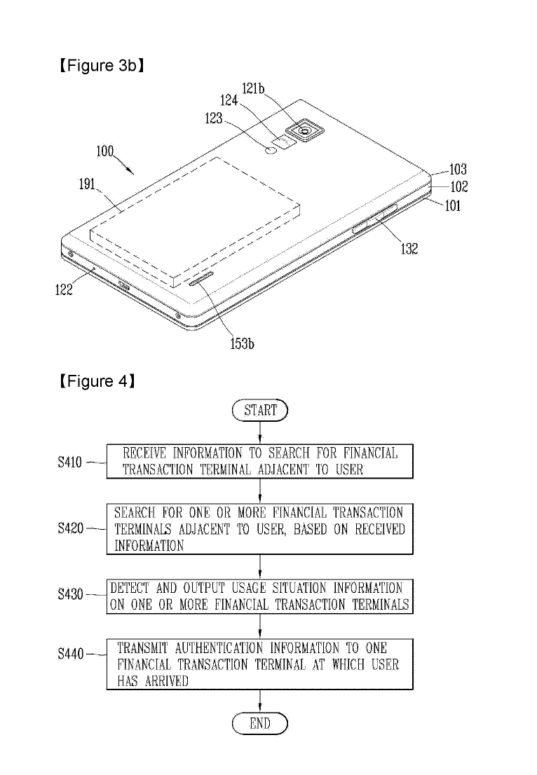

FIG. 3A is a front perspective view illustrating an example of the mobile terminal 100 associated with the present disclosure.

The mobile terminal 100 disclosed herein is provided with a bar-type terminal body. However, the present invention may not be limited to this, but also may be applicable to various structures such as watch type, clip type, glasses type or folder type, flip type, swing type, swivel type, or the like, in which two and more bodies are combined with each other in a relatively movable manner.

The body includes a case (casing, housing, cover, etc.) forming the appearance of the terminal. In this embodiment, the case may be divided into a front case 101 and a rear case 102. Various electronic components is incorporated into a space formed between the front case 101 and the rear case 102. At least one middle case may be additionally disposed between the front case 101 and the rear case 102, and a battery cover 103 for covering the battery 191 may be detachably configured at the rear case 102.

The cases may be formed by injection-molding a synthetic resin or may be also formed of a metal, for example, stainless steel (STS), titanium (Ti), or the like.

A display unit 151, a first audio output module 153a, a first camera 121a, a first manipulating unit 131 and the like may be disposed on a front surface of the terminal body, and a microphone 122, an interface unit 170, a second manipulating unit 132 and the like may be provided on a lateral surface thereof.

The display unit 151 may be configured to display (output) information being processed in the mobile terminal 100. The display unit 151 may include at least one of a liquid crystal display (LCD), a thin film transistor-liquid crystal display (TFT-LCD), an organic light emitting diode (OLED) display, a flexible display, a 3-dimensional (3D) display, and an e-ink display.

The display unit 151 may include a touch sensing means to receive a control command by a touch method. When a touch is made to any one place on the display unit 151, the touch sensing means may be configured to sense this touch and enter the content corresponding to the touched place. The content entered by a touch method may be a text or numerical value, or a menu item capable of indication or designation in various modes.

The touch sensing means may be formed with transparency to allow visual information displayed on the display unit 151 to be seen, and may include a structure for enhancing the visibility of a touch screen at bright places. Referring to FIG. 3A, the display unit 151 occupies a most portion of the front surface of the front case 101.

The first audio output unit 153a and the first camera 121a are disposed in a region around or adjacent to one of both ends of the display unit 151, and the first manipulation user input unit 131 and the microphone 122 are disposed in a region around or adjacent to the other end thereof. The second manipulation interface 132 (refer to FIG. 3B), the interface 170, and the like may be disposed on a lateral surface of the terminal body.

The first audio output module 153a may be implemented in the form of a receiver for transferring voice sounds to the users ear or a loud speaker for outputting various alarm sounds or multimedia reproduction sounds.

It may be configured such that the sounds generated from the first audio output module 153a are released along an assembly gap between the structural bodies. In this case, a hole independently formed to output audio sounds may not be seen or hidden in terms of appearance, thereby further simplifying the appearance of the mobile terminal 100. However, the present invention may not be limited to this, but a hole for releasing the sounds may be formed on the window.

The first camera 121a processes video frames such as still or moving images obtained by the image sensor in a video call mode or capture mode. The processed video frames may be displayed on the display unit 151.

The user input unit 130 is manipulated to receive a command for controlling the operation of the mobile terminal 100. The user input unit 130 may include a first and a second manipulation unit 131, 132. The first and the second manipulation unit 131, 132 may be commonly referred to as a manipulating portion, and any method may be employed if it is a tactile manner allowing the user to perform manipulation with a tactile feeling such as touch, push, scroll or the like.

In the present drawing, it is illustrated on the basis that the first manipulation unit 131 is a touch key, but the present disclosure may not be necessarily limited to this. For example, the first manipulation unit 131 may be configured with a mechanical key, or a combination of a touch key and a mechanical key.

The content received by the first and/or second manipulation units 131, 132 may be set in various ways. For example, the first manipulation unit 131 may be used to receive a command such as menu, home key, cancel, search, or the like, and the second manipulation unit 132 may receive a command, such as controlling a volume level being outputted from the first audio output module 153a, or switching into a touch recognition mode of the display unit 151.

The microphone 122 may be formed to receive the user's voice, other sounds, or the like. The microphone 122 may be provided at a plurality of places, and configured to receive stereo sounds.

The interface unit 170 serves as a path allowing the mobile terminal 100 to exchange data with external devices. For example, the interface unit 170 may be at least one of a connection terminal for connecting to an earphone in a wired or wireless manner, a port for near field communication (for example, an Infrared Data Association (IrDA) port, a Bluetooth port, a wireless LAN port, and the like), and a power supply terminal for supplying power to the mobile terminal 100. The interface unit 170 may be implemented in the form of a socket for accommodating an external card such as Subscriber Identification Module (SIM) or User Identity Module (UIM), and a memory card for information storage.

FIG. 3B is a rear perspective view illustrating mobile terminal 100 illustrated in FIG. 3A.

Referring to FIG. 3B, a second camera 121b may be additionally mounted at a rear surface of the terminal body, namely, the rear case 102. The second camera 121b has an image capturing direction, which is substantially opposite to the direction of the first camera unit 121a (refer to FIG. 3A), and may have a different number of pixels from that of the first camera unit 121a.

For example, it is preferable that the first camera 121a has a relatively small number of pixels enough not to cause difficulty when the user captures his or her own face and sends it to the other party during a video call or the like, and the second camera 121b has a relatively large number of pixels since the user often captures a general object that is not sent immediately. The first and the second camera 121a, 121b may be provided in the terminal body in a rotatable and poppable manner.

Furthermore, a flash 123 and a mirror 124 may be additionally disposed adjacent to the second camera 121b. The flash 123 illuminates light toward an object when capturing the object with the second camera 121b. The mirror 124 allows the user to look at his or her own face, or the like, in a reflected way when capturing himself or herself (in a self-portrait mode) by using the second camera 121b.

A second audio output unit 153b may be additionally disposed at a rear surface of the terminal body. The second audio output unit 153b together with the first audio output unit 153a (refer to FIG. 3A) can implement a stereo function, and may be also used to implement a speaker phone mode during a phone call.

An antenna (not shown) for receiving broadcast signals may be additionally disposed at a lateral surface of the terminal body in addition to an antenna for making a phone call or the like. The antenna constituting part of the broadcast receiving module 111 (refer to FIG. 1) may be provided in the terminal body in a retractable manner.

A power supply unit 190 (refer to FIG. 1) for supplying power to the mobile terminal 100 may be mounted on the terminal body. The power supply unit 190 may be incorporated into the terminal body, or may include a battery 191 configured in a detachable manner on the outside of the terminal body. According to the drawing, it is illustrated that the battery cover 103 is combined with the rear case 102 to cover the battery 191, thereby restricting the battery 191 from being released and protecting the battery 191 from external shocks and foreign substances.

The mobile terminal is configured to transmit and receive position information through a GPS, etc. For instance, the mobile terminal may be provided with information on a position of an ATM around or adjacent to a user's position.

However, in this case, a user's financial transaction institution, a transaction type, a transaction amount and a user's schedule cannot be considered. Further, when a user requests another person to perform a transaction using a user's account, or when the user inputs his or her account number or password for an ATM transaction, personal information may leak to outside.

Hereinafter, the mobile terminal 100 capable of enhancing a user's convenience by considering a user's position, a financial transaction type and situations, and a control method thereof will be explained in more detail with reference to the attached drawings.

In describing the present invention, “the user's position” means “a location of the mobile terminal.

FIG. 4 is a flowchart to explain the mobile terminal 100 according to an embodiment of the present invention.

The mobile terminal 100 includes the user input unit 130, the controller 180 and the display unit 151.

Referring to FIG. 4, a user inputs information to be considered to search for a financial transaction terminal around or adjacent to himself or herself (S410).

More specifically, the user may input a financial transaction institution, a financial transaction type, a transaction amount, his or her schedules, etc., as information to be considered to search for a financial transaction terminal such as an ATM.

Next, the user searches for one or more financial transaction terminals around or adjacent to himself or herself, based on the information to be considered to search for a financial transaction terminal (S420).

In an embodiment, one or more financial transaction terminals may be searched by considering a user's moving path calculated based on the user's input schedules.

Then, information on a usage situation of said one or more financial transaction terminals is detected to be output (S430).

More specifically, a position of a financial transaction terminal, the number of users, a waiting time for usage, etc. may be searched based on the usage situation information, and they may be output.

Once the user moves to arrive at one of said one or more financial transaction terminals, the authentication information input by the user is transmitted to said one financial transaction terminal (S440).

More specifically, the user may input a fingerprint, a password, a face photo, etc. as the authentication information.

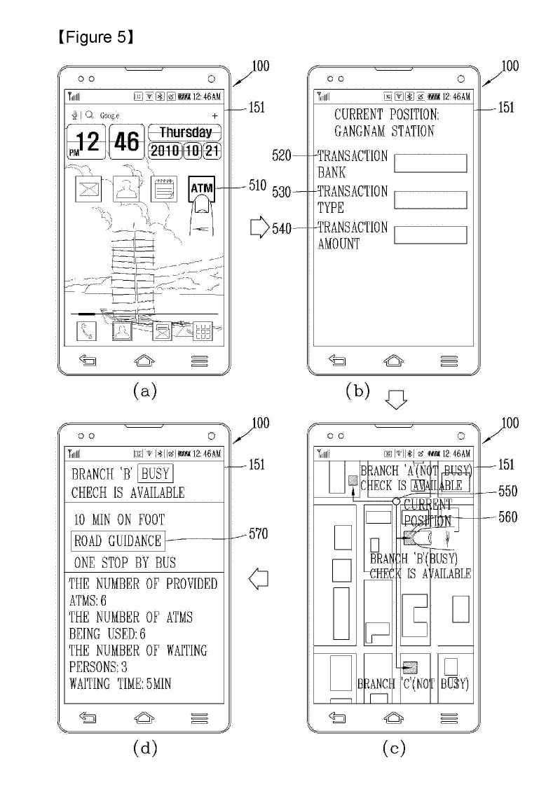

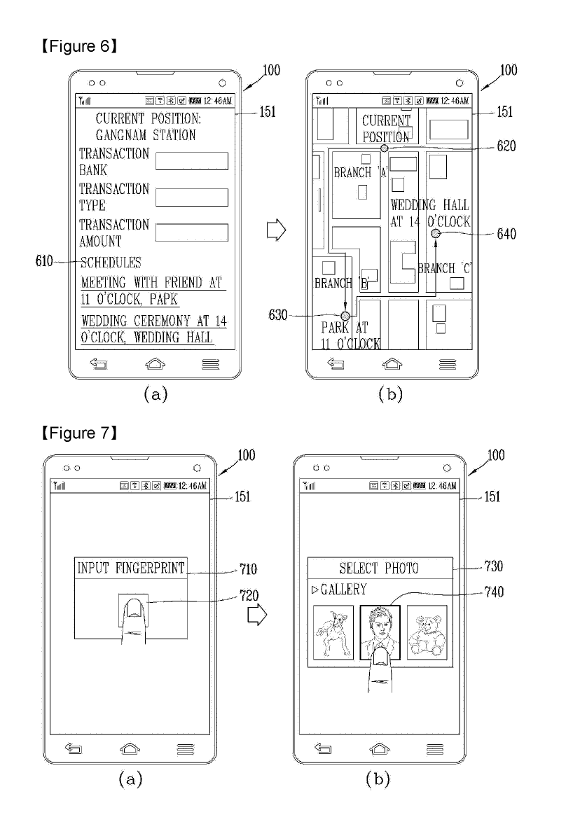

FIGS. 5 and 6 are conceptual views illustrating an embodiment of a user interface for searching for a financial transaction terminal with consideration of search conditions and a user's position.

Referring to FIGS. 5(a) and 5(b), once a user touches an icon 510 for searching for an adjacent financial transaction terminal, a user interface for inputting information to be considered to search for a financial transaction terminal close to the user may be output.

More specifically, the user may input a transaction bank 520, a transaction type 530, a transaction amount 540, etc. as information. For instance, the user may input a name of a desired bank to the transaction. The user may input a transaction type such as a deposit, a transfer, a withdrawal and a loan, to the transaction type 530. To the transaction amount 540, the user may input a total amount to be transacted according to a transaction type, whether to pay by check or by cash, a type of a bill to be used, etc.

Referring to FIG. 5(c), adjacent financial transaction institutions (branches ‘A’, ‘B’ and ‘C’) including financial transaction terminals may be output, based on a user's position and the input information of FIG. 5(b).

More specifically, a user's current position 550 and searched branches may be output in the form of a map. The respective branches may be output with brief information on whether they are available, whether a check can be used, etc.

Referring to FIG. 5(d), once a user touches a branch ‘B’ 560 of FIG. 5(c), detailed usage information on the branch ‘B’ 560 may be output.

More specifically, whether an ATM can be immediately used or not, and whether checks can be withdrawn or not may be output. Further, time taken to move from the current position to the branch ‘B’ 560, utilizable traffic means, etc. may be output.

As one example, if a user selects a road guidance icon 570 in a touch manner, a road guidance to the branch ‘B’ 560 may be performed real time.

As another example, the number of ATMs provided at the branch ‘B’ 560, the number of ATMs being currently utilized, the number of waiting persons, waiting time, etc. may be output as situation information. Information on waiting persons may be checked through situations of a branch doorway, or a CCTV inside the branch ‘B’ 560.

Referring to FIG. 6(a), a user may input his or her schedules 610 as information to be considered to search for an adjacent financial transaction terminal. For instance, a user may input a meeting time, a meeting place, etc.

Referring to FIG. 6(b), a user's moving path may be calculated based on a user's current position and the input schedules of FIG. 6(a). Then adjacent financial transaction terminals on the moving path may be searched to be output to the map.

As an example, a branch ‘A’ around or adjacent to a user's current position 620, a branch ‘B’ around or adjacent to a moving path from the current position 620 to a park 630 (i.e., a meeting place at 11 o'clock), and a branch ‘C’ around or adjacent to a moving path from the park 630 to a wedding hall 640 (i.e., a meeting place at 14 o'clock) may be output to the map.

If a user moves to reach one of one or more searched financial transaction terminals, authentication information may be transmitted to said one financial transaction terminal.

FIG. 7 is a conceptual view illustrating an embodiment of a user interface for transmitting authentication information.

Referring to FIG. 7(a), once a user approaches to a single ATM for transaction, a popup window 710 for indicating input of a fingerprint may be output. Then the user may input his or her fingerprint in a touch manner, and the input fingerprint may be transmitted to the ATM.

In an embodiment, the ATM may determine that the user's mobile terminal 100 has approached for transaction, based on signals transceived between the mobile terminal 100 and itself, and based on a GPS function. Further, the ATM may determine whether the user can approach to an account by comparing a user's pre-stored fingerprint with a user's newly-input fingerprint.

Referring to FIG. 7(b), once a user approaches to a single ATM for transaction, a popup window 730 for indicating input of a photo may be output. Once the user selects a face photo 740 for authentication from the memory of the mobile terminal 100, the selected photo 740 may be transmitted to the ATM.

Likewise, the ATM may determine that the user's mobile terminal 100 has approached thereto for transaction, based on signals transceived (transmitted and received) between the mobile terminal 100 and itself, and based on a GPS function. Further, the ATM may determine whether a user can approach to an account by comparing a user's pre-stored face photo with a user's newly-input face photo.

In another embodiment, an authentication process may be performed as a user inputs an account password, etc. to the mobile terminal 100, or based on NFC information such as a QR code or a barcode arranged at the ATM.

A user who has arrived at an adjacent ATM may perform a financial transaction by accessing another person's account, after being authenticated with respect to another person's account, as well as his or her account.

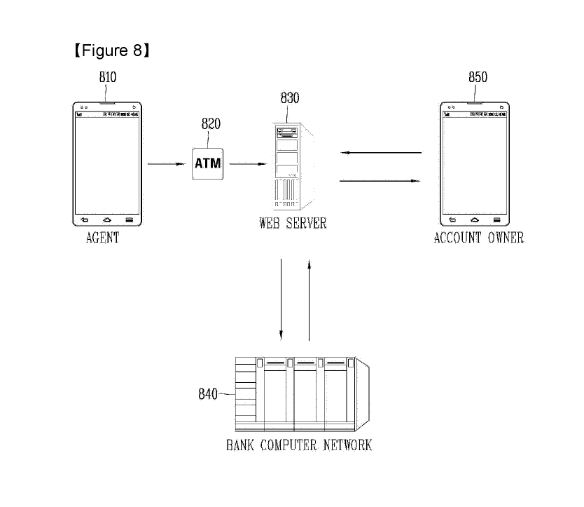

FIG. 8 is a conceptual view illustrating an embodiment to access another person's account.

Referring to FIG. 8, an agent who has arrived at an adjacent ATM 820 may transfer authentication information such as a fingerprint, a password and a photo, to the ATM 820, through a mobile terminal 810. Then, the agent may request an account information investigation from a bank computer network 840, through a web server 830. The bank computer network 840 may encode an authentication certificate public key, and transmit it to the web server 830.

The web server 830 may request decoding of the authentication certificate public key, from an account owner's mobile terminal 850. The account owner may check whether the agent is right through the mobile terminal 850. Then the account owner may encode an authentication content personal key to transmit it to the web server 830.

The bank computer network 840 may decode authentication content personal key transmitted to the web server 830, thereby approving account usage. As a result, the agent may perform a financial transaction by accessing another person's account.

An agent's authentication information may be output from an account owner's mobile terminal.

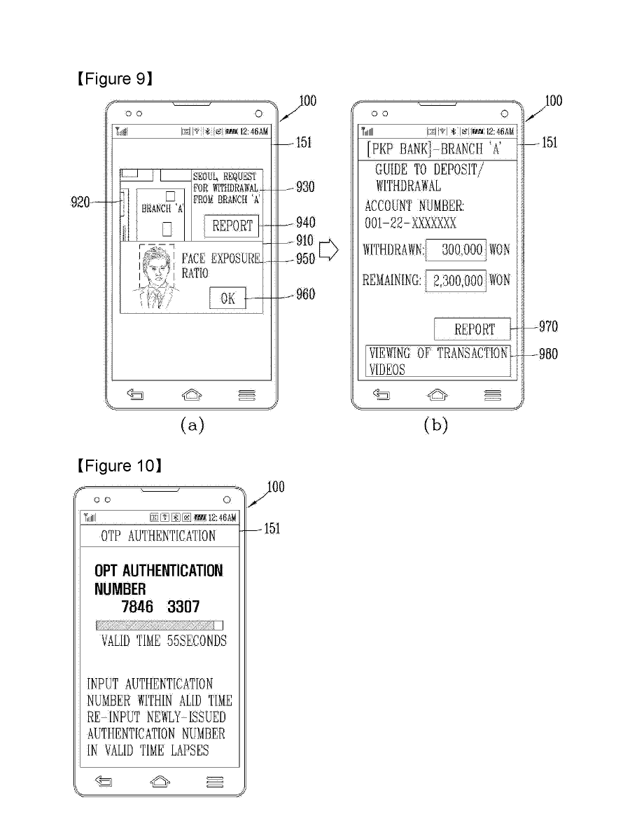

FIG. 9 is a conceptual view illustrating an embodiment of authentication information transmitted to an account owner.

Referring to FIG. 9(a), a message window 910 for checking whether an agent is right or not may be output to an account owner's mobile terminal. More specifically, a map 920 indicating a position of a branch at which an agent has arrived, content of a transaction requested from the branch 930, etc. may be output.

An agent's face photo input from an agent's mobile terminal, a face exposure ratio 950, etc. may be output. In an embodiment, if an exposure ratio of the agent's face is more than a predetermined %, the agent's face may be searched from a photo album, an address book, etc. for analysis of the agent's face in a matching manner.

In a case where the account owner has not requested a withdrawal from the agent, or in a case where the agent is not a right person, the account owner may touch a report icon 940 to inform a security member inside a branch or a neighboring police station of the fact.

In a case where the agent is a right person for withdrawal, the account owner touches an authentication icon 960. The agent may withdraw a predetermined amount of money from the account owner's account. In an embodiment, the agent's withdrawable amount of money, or an upper limit value of the amount may be set.

Referring to FIG. 9(b), information on a transaction bank, a branch, an account number used for transaction, the amount of money withdrawn by the agent, a remaining amount of money, etc. may be output to the account owner's terminal. If a transaction is illegal, the account owner may touch a report icon 970 to inform a corresponding branch of the illegal transaction.

In an embodiment, if the account owner touches a transaction image viewing icon 980, images may be output. In this case, the images correspond to a time duration from a time point when the agent has logged on the account owner's account, to a time point when the agent has logged out for transaction ending. Such images may be captured by a camera of an ATM used by the agent.

In still another embodiment, if the agent authorized for prevention of a financial transaction accident has not input specific information within a predetermined time, the account owner may be informed of the fact.

In this case, the account owner may request the agent to perform a financial transaction using his or her account, without informing the agent of personal information. The account owner may real time receive transaction procedures using his or her account.

In another embodiment, the account owner may issue an electronic check for withdrawing a predetermined amount of money from his or her account, or an SMS. Then, the account owner may transmit the electronic check or the SMS to the agent. As aforementioned, a procedure for authenticating the agent by the account owner may be performed. Accordingly, in a case where a card payment is difficult or there is no cash, a payment may be performed using an electronic check or an SMS.

A virtual account corresponding to a desired account for a financial transaction may be generated whenever an event of the financial transaction occurs. More specifically, the account owner may generate a virtual account associated with his or her account whenever another party performs a financial transaction, and may transmit the virtual account. Said another party indicates a person who performs a financial transaction using the account owner's account.

In an embodiment, if another party transfers cash to the account owner's account through an ATM, the account owner's terminal may generate a virtual account corresponding to the account owner's account. Then, the account owner's terminal may transmit the virtual account to another party's terminal of which number has been input by the account owner.

More specifically, a virtual account may be generated at random, in an encoding manner using a random number generation algorithm such as an one-time password (OTP), not in a fixed manner using a security card.

The generated virtual account may be transmitted to the input another party's terminal, and may be registered to the ATM through a bank computer network. Under such configuration, synchronization may be performed through the virtual account and a real account.

Said another party who has received the virtual account may not input a real bank and the account owner's account to the ATM, but may input only a virtual account to perform a cash transfer. Accordingly, the ATM may transfer a required amount of money to the account owner's account associated with the received virtual account.

Upon completion of the transfer, the virtual account registered to the ATM is deleted, and an additional transfer, etc. cannot be performed using the already-used virtual account. That is, a virtual account may be generated whenever an event such as transfer, deposit and withdrawal occurs. A virtual account may be also generated when a consecutive transfer or a consecutive deposit is performed.

In another embodiment, a virtual account corresponding to the account owner's account may be generated, and may be transmitted to the aforementioned agent.

FIG. 10 is a conceptual view illustrating an embodiment of a user interface for transmitting a virtual account number.

Referring to FIG. 10, another party's terminal may receive an OTP authentication number. Another party may input the received OTP authentication number to the ATM, and may transfer cash. The already-used OTP authentication number cannot be re-used after the transfer.

As a result, a user needs not remember or input a real account number. Further, as the virtual account number is deleted after cash transfer, personal information can be protected.

The mobile terminal 100 of the present invention may be implemented as smart glasses. The user input unit 130 may be implemented as a virtual keypad. Once a user arrives at one of one or more searched financial transaction terminals, the virtual keypad can receive inputtable signals from said one financial transaction terminal, and can recognize the received signals through the smart glasses.

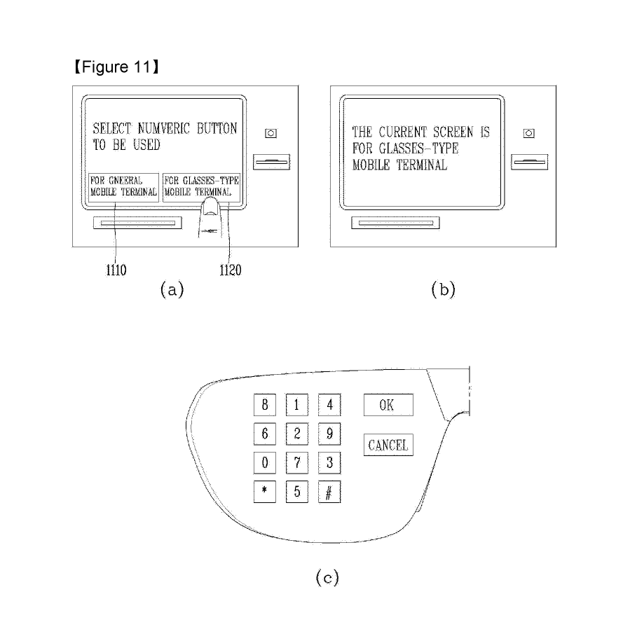

FIG. 11 is a conceptual view illustrating an embodiment where the mobile terminal of the present invention is implemented as smart glasses.

Referring to FIG. 11(a), a user interface for selecting numeric buttons to be used may be output to an ATM. More specifically, an icon 1110 for a general mobile terminal, and an icon 1120 for a glasses-type mobile terminal are output to the ATM. Once a user touches the icon 1110 for a general mobile terminal, the existing numeric buttons are output to the ATM.

Referring to FIG. 11(b), if a user touches the icon 1120 for a glasses-type mobile terminal from FIG. 11(a), a message recommending to wear a glasses-type mobile terminal may be output. If the user does not wear a glasses-type mobile terminal, the user can see only an empty screen of the ATM as shown in FIG. 11(b).

Referring to FIG. 11(c), if the user sees the screen of the ATM with wearing a glasses-type mobile terminal, a numeric keypad is output to the screen of a glasses-type mobile terminal as a camera of the glasses-type mobile terminal recognizes a touch keypad for a glasses-type mobile terminal.

More specifically, the glasses-type mobile terminal may receive inputtable signals from the ATM, and may output a keypad at different positions using a random number generating algorithm. Once the user wearing the glasses-type mobile terminal may touch the screen of the ATM corresponding to the keypad of the glasses-type mobile terminal, coordinate values of the generated keypad are input to the ATM so that an account number, a password, etc. can be input.

In another embodiment, the smart glasses 100 may recognize serial numbers of checks to be deposited to the ATM or checks withdrawn from the ATM, and then may output information on the checks.

More specifically, the smart glasses 100 search the serial numbers viewed from the user, through text cognition, at a financial computer network. Then, the smart glasses 100 may output, to the user, information on issue data, an issue place, a usage history, etc.

In another embodiment, the smart glasses 100 may recognize serial numbers of a plurality of checks to be deposited to the ATM or checks withdrawn from the ATM, and then may output information on each of the plurality of checks.

More specifically, in case of checking a small amount of checks, information on the checks is real time output. On the other hand, in case of checking a large amount of checks, the checks are multi-captured in a consecutive manner, and then searched results may be output.

Accordingly, the user needs not remember or input serial numbers of checks or cash, and can easily detect whether checks or cash is in a stolen state.

Upon arrival at a place around or adjacent to a plurality of financial transaction terminals, the user may perform a touch input to search for one of the financial transaction terminals, using the user input unit 130.

The controller 180 may select one of the plurality of financial transaction terminals based on the user's position. Upon the user's touch input, the controller 180 may calculate a positional relation between the user and the selected financial transaction terminal.

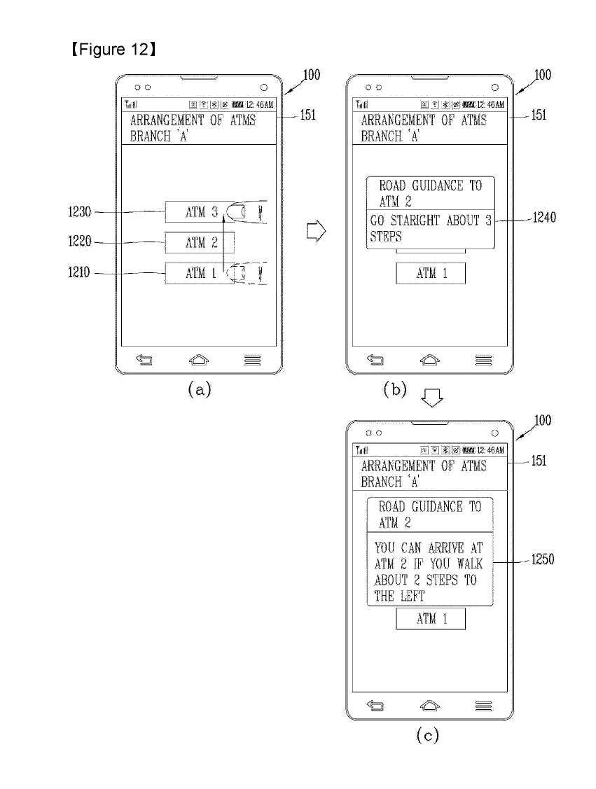

FIG. 12 is a conceptual view illustrating an embodiment to guide a position of an automatic teller machine (ATM).

Referring to FIG. 12(a), a plurality of ATMs provided at a branch at which a user has arrived, may be arranged on a screen of the mobile terminal 100 from the lower side to the upper side, in order of short distances from the user's current position. For instance, ATM 1 (1210), ATM 2 (1220) and ATM 3 (1230) may be output in order of short distances from the user's current position.

In a case where the ATM 2 (1220) and the ATM 3 (1230) are spaced from the user's current position by the same distance, the ATM 2 (1220) having a cheaper transaction fee may be output to a lower side. Alternatively, the ATM 2 (1220) having a smaller number of waiting persons may be output to a lower side.

Once the user performs a drag input or a scroll input from the lower side to the upper side of the screen to which the ATM 1 (1210), the ATM 2 (1220) and the ATM 3 (1230) have been output, the ATM on which the user's finger touches is output in an audible manner or in a vibration manner.

For instance, if the user's finger touches the ATM 1 (1210) while performing a scroll input from the lower side to the upper side, the position of the ATM 1 (1210) may be output in the form of a vibration, a voice, or a message. More specifically, a sound, which indicates that the ATM 1 (1210) is located at a left front side by 1m from the user's current position, may be output. Alternatively, a pop-up window indicating the fact may be output.

Likewise, if the user's finger touches the ATM 2 (1220) and the ATM 3 (1230) while continuously performing the scroll input from the lower side to the upper side, the positions of the ATM 2 (1220) and the ATM 3 (1230) may be output in the form of vibrations, voices or message windows.

Referring to FIG. 12(b), if the user selects the ATM 2 (1220) by touching or double-douching the screen of the mobile terminal 100 shown in FIG. 12(a), a road guidance to the ATM 2 (1220) is output real time. More specifically, a message window 1240, which instructs the user to go straight about 3 steps from the current position, may be output.

Referring to FIG. 12(c), if the user goes straight about 3 steps according to the road guidance of FIG. 12(b), a message window 1250, which instructs the user to turn left about 2 steps, from the position obtained after the user has walked about 3 steps toward the ATM 2 (1220), may be output.

In another embodiment, such road guidance message may be output in the form of a voice. The user may wear an ear-microphone so that the road guidance voice can be prevented from leaking to outside.

In still another embodiment, a voice guidance or an inducing sound may be output whenever the user touches or double-touches the screen of the mobile terminal 100 while moving.

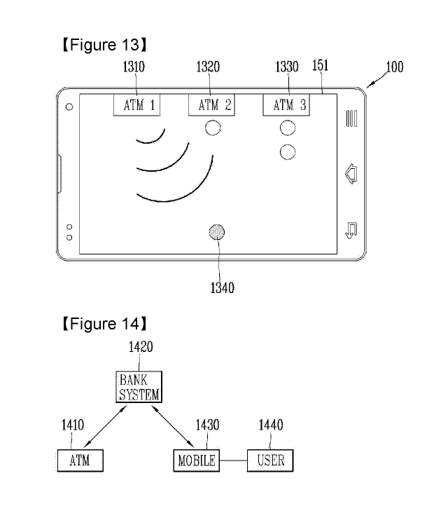

FIG. 13 is a conceptual view illustrating positions of a user and ATMs.

Referring to FIG. 13, in a case where the number of waiting persons for an ATM 2 (1320) is 1 and the number of waiting persons for an ATM 3 (1330) is 2, an inducing sound may be output from an ATM 1 (1310) where there is no waiting person. More specifically, a song, a sound effect, etc. may be output from a position of the ATM 1 (1310), i. e, a left front side based on a user's position 1340.

FIG. 14 is a conceptual view illustrating an embodiment to transmit data between a mobile terminal of the present invention and an ATM.

Referring to FIG. 14, once a user arrives at an ATM (1410), the ATM (1410) may transmit a voice and a sound feedback to a user 1440, through a user's mobile terminal 1430.

More specifically, a voice and a sound may be transmitted to a bank system 1420 from the ATM 1410, and the voice and the sound may be transmitted to the mobile terminal 1430 from the bank system 1420. For instance, whether the user is to arrive at the ATM 1410 or not, withdrawal information, etc. may be transmitted in the form of a voice and a sound. The user may wear an ear-microphone, etc. for protection of personal information, and so as to prevent leakage of personal information to other persons.

Likewise, a control command or a specific signal input from the mobile terminal 1430 may be transmitted to the ATM 1410 via the bank system 1420.

The transmission procedures can be performed when the user 1440 indirectly controls the ATM 1410 through the mobile terminal 1430, as well as when the user 1440 directly controls the ATM 1410. That is, the user 1440 may not directly input a password or a key value to a panel of the ATM 1410, but may indirectly input it by touch or drag on the mobile terminal 1430.

In still another embodiment, upon the user's arrival at the ATM, a security guard of the ATM may be notified of the user's arrival so that a stealth accident, etc. which can occur during a financial transaction can be prevented.

In still another embodiment, if the user arrives at the ATM and then pays the amount of money to be deposited or to be withdrawn, through the mobile terminal 100, a temporary key value may be generated. Accordingly, an NFC application, through which the user transmits the temporary key value, may be executed. Further, a sound may be output from a position of the ATM where an NFC sensor is touchable.

The NFC sensor of the ATM may be positioned at a door for depositing/withdrawing cash. Upon completion of the user's authentication as the temporary key value is transmitted, the door for depositing/withdrawing cash is open so that the user can deposit/withdraw cash.

In the present invention, a financial transaction terminal can be searched with consideration of a financial institution to be transacted by a user, a transaction type, the amount of money and a user's schedules.

Further, authentication information can be transmitted when a user requests another person to perform a transaction using the user's account. Further, an encoded virtual account number may be generated at the time of each transaction. Further, as the mobile terminal of the present invention is implemented as smart glasses, personal information can be input through a keypad output in a new form each time. Accordingly, personal information can be protected, and a user's convenience can be enhanced.

The aforementioned method may be implemented as a program code stored in a computer-readable storage medium. The storage medium may include ROM, RAM, CD-ROM, a magnetic tape, a floppy disc, an optical data storage device, etc. The storage medium may be also implemented as carrier wave (transmission through the Internet).

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

1. A mobile terminal for communicating position information, the mobile terminal comprising:
a user input unit configured to receive at least one of information to be considered to search for a financial transaction terminal around the mobile terminal, and authentication information;
a controller configured to search for one or more financial transaction terminals around the mobile terminal, based on the information to be considered to search for a financial transaction terminal, and configured to receive usage situation information on said one or more financial transaction terminals; and
a display unit configured to output the usage situation information,
wherein when a location of the mobile terminal changes to a place adjacent to one of said one or more financial transaction terminals, the controller configured to transmit the authentication information to said one financial transaction terminal.

2. The mobile terminal of claim 1, wherein the user input unit is configured to receive at least one of a financial institution to be transacted by the user, a transaction type, the amount of money, and a user's schedules, as information to be considered to search for the financial transaction terminal.

3. The mobile terminal of claim 2, wherein the controller is configured to search for said one or more financial transaction terminals, with consideration of a moving path calculated based on the input user's schedules.

4. The mobile terminal of claim 1, wherein the user input unit configured to receive at least one of the user's fingerprint, password and face photo, as the authentication information.

5. The mobile terminal of claim 1, wherein the controller configured to generate a virtual account corresponding to a desired account for a financial transaction whenever an event of the financial transaction occurs.

6. The mobile terminal of claim 1, wherein the display unit configured to output authentication information of another person who is to access a user's account.

7. The mobile terminal of claim 1, wherein when a location of the mobile terminal changes to a place adjacent to a plurality of financial transaction terminals, the user input unit is configured to receive the touch input to search for one of the financial transaction terminals, and
wherein the controller is configured to select one of the plurality of financial transaction terminals based on the mobile terminal's position, and calculates a positional relation between the mobile terminal and the selected financial transaction terminal upon a touch input.

8. The mobile terminal of claim 1, wherein the mobile terminal is implemented as smart glasses, and
wherein the user input unit is implemented as a virtual keypad which can receive inputtable signals from one of said one or more financial transaction terminals, and can recognize the received signals through the smart glasses, if the user arrives at said one financial transaction terminal.

9. A method for controlling a mobile terminal, the method comprising:
(a) receiving, information to be considered to search for a financial transaction terminal around the mobile terminal;
(b) searching for one or more financial transaction terminals the around the mobile terminal, based on the information to be considered to search for a financial transaction terminal;
(c) receiving and outputting usage situation information on said one or more financial transaction terminal; and
(d) when a location of the mobile terminal changes to a place adjacent to one of said one or more financial transaction terminals, transmitting authentication information input by the user to said one financial transaction terminal.

10. The method of claim 9, wherein the step (a) includes receiving at least one of a financial institution to be transacted by the user, a transaction type, the amount of money, and a user's schedules, as information to be considered to search for the financial transaction terminal.

11. The method of claim 10, wherein the step (b) includes searching for said one or more financial transaction terminals, by considering a moving path calculated based on the received user's schedules.

12. The method of claim 9, wherein the step (d) includes receiving at least one of a user's fingerprint, password and face photo, as the authentication information.

13. The method of claim 9, wherein the step (d) includes generating a virtual account corresponding to a desired account for a financial transaction whenever an event of the financial transaction occurs.

14. The method of claim 9, wherein the step (d) includes outputting authentication information of another person who is to access a user's account.

15. The method of claim 9, wherein the step (c) includes selecting one of a plurality of financial transaction terminals based on the mobile terminal's position when a location of the mobile terminal changes to a place adjacent to the plurality of financial transaction terminals,
and calculating a positional relation between the mobile terminal and the selected financial transaction terminal upon a touch input to arrive at the selected financial transaction terminal, and
wherein the step (d) includes transmitting authentication information received from the mobile terminal, to the selected financial transaction terminal, when a location of the mobile terminal changes to a place adjacent to the selected financial transaction terminal.

16. The method of claim 9, wherein the step (a) includes receiving inputtable signals from one of said one or more financial transaction terminals, and outputting a virtual keypad recognizable through smart glasses, if the user arrives at said one financial transaction terminal.
